(19) United States
(12) Patent Application Publication
(10) Pub. No.: US 2008/0013184 A1
(43) Pub. Date: Jan. 17, 2008

(54) HEAD'S UP DISPLAY AMBIGUITY ELIMINATOR

(75) Inventor: Charles B. Swope, Coral Springs, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Plantation, FL (US)

(21) Appl. No.: 11/457,638

(22) Filed: Jul. 14, 2006

(51) Int. Cl. G02B 27/14

(52) U.S. Cl. 359/630

(57) ABSTRACT

A display device and method (300) includes a processor (718) and a head's up display (HUD) (112) that provides direction or exit route indicators to a user's peripheral line of vision in the form of a plurality of light sources (41 or 722) such as LEDs along a scan line of the HUD. The processor can activate (304) a first light source along the scan line within an ambiguous zone (40) and activate (306) a second light source a predetermined distance away from the first light source as the first and second light sources scan through the ambiguous zone. Note, a point between the first and second light source indicates a desired direction or exit route. A location of the second light source can be activated based on one or more of a scan rate, a distance the HUD is away from a user's eyes, a user's eye spacing, or the ambiguous zone.

### FIELD

This invention relates generally to displays used for tracking, and more particularly to a method and system of eliminating ambiguity when using a display indicator.

### BACKGROUND

Tactical in-building location solutions are becoming increasingly popular in first responder security situations. In the event of a man-down situation, a tactical system can identify and locate an individual under duress, select a resource unit closest to the incident, direct a rescue intervention team to the man-down using that resource unit, and then direct the team and rescued individual out to the safest location. The tactical approach requires a significant amount of resources including a very reliable radio frequency (RF) location system.

There exist some in-building rescue systems that can be carried by rescue personnel and deployed with little interaction from remote resources. Personal area network (PAN) devices generally refer to a computer network used close to one person. However, many of the PAN systems must be carried by hand and are bulky, cumbersome and hard to manage during rescue operations. The visual displays of such systems, if any, are typically mounted in the search unit carried by the rescue personnel. During intense smoke or moisture the display may become non-functional.

Newer face masks are being developed to facilitate rescue personnel. Self contained breathing apparatus (SCBA) devices may include a display mounted in the nose section of the facemask to provide the status of airtime, temperature and pressure. However, SCBA displays require the rescue personnel to visually focus on the display which can distract the user from the current task. Head's up displays (HUD) for use on fire helmets are being developed to overcome some of the existing detriments.

Several observations have been reported by users of HUDs under test conditions. The most prevalent observation was the boresight scan “blanking” observed during a search mode. In this experiment, the HUD was set up to scan 64 LEDS across the HUD in consecutive order. During the search scan, there appeared to be a jump in time at the boresight. It was determined that since humans have a dominant eye, the strong eye tries to take over as soon as it captures light from the LED during the scan from the weak eye to the strong eye even. This effect appears as a “jump” in the LEDs to the user when in actuality the scan moves smoothly across the HUD.

While initially some users may find the “jump” somewhat annoying, after a few minutes, the dominant eye and brain seem to compromise or compensate and the “jump” can be tolerated. Even so, to avoid any possible misdirection in navigation using the HUD it would be desirable to compensate for the “jump” in an ambiguous region.

### SUMMARY

Embodiments in accordance with the present invention can provide a compensation method and system for ambiguous direction indicators used on displays such as head's up displays.

In a first embodiment of the present invention, a display device can include a head's up display (HUD) that provides direction indicators or exit route indicators to a user's peripheral line of vision in the form of a plurality of light sources along a scan line of the HUD and a processor coupled to the indicators. The processor can be programmed to activate a first light source among the plurality of light sources along the scan line within an ambiguous zone and activate a second light source a predetermined distance away from the first light source within the ambiguous zone as the first light source and second light source scan through the ambiguous zone. Note, a point between the first light source and the second light source indicates a desired direction or an exit route. The plurality of light sources can include a plurality of light emitting diodes (LEDs). A location of the second light source can be activated based on at least one or more of a scan rate, a distance the HUD away from a user's eyes, a user's eye spacing, or the ambiguous zone. The light sources can be phase modulated at a greater rate than 20 Hertz and can be one hundred eighty degrees out of phase. The processor can be further coupled to a monopulse receiver and the monopulse receiver can be coupled to a plurality of antennas.

In a second embodiment of the present invention, a communication system can include a head's up display (HUD) that provides direction indicators or exit route indicators to a user's peripheral line of vision. The communication system can further include a plurality of light sources along a scan line of the HUD automatically activated and controlled to provide an optical illusion to a user within an ambiguous zone of the HUD to provide the direction indicators or exit route indicators. The communication system can also include a processor coupled to the indicators. The processor can be programmed to activate a first light source among the plurality of light sources along the scan line within an ambiguous zone and activate a second light source a predetermined distance away from the first light source within the ambiguous zone as the first light source and second light source scan through the ambiguous zone. A point between the first light source and the second light source indicates a desired direction or an exit route. The plurality of light sources can be a plurality of light emitting diodes (LEDs). The location of the second light source can be activated based on at least one or more of a scan rate, a distance the HUD is away from a user's eyes, a user's eye spacing, or the ambiguous zone. The first light source or the second light source can be phase modulated at greater than 20 Hertz and is one hundred eighty degrees out of phase. The processor can be further coupled to a monopulse receiver and the monopulse receiver can be coupled to an antenna array. The communication can further include a base station generating a signal including egress data for a predetermined area and a personal area network device coupled to the processor communicating with the base station.

In a third embodiment of the present invention, a method of providing direction indicators or exit route indicators to a user's peripheral line of vision in the form of a plurality of light sources along a scan line of a head's up display (HUD), comprising the steps of activating a first light source among the plurality of light sources along the scan line within an ambiguous zone and activating a second light source a predetermined distance away from the first light source within the ambiguous zone as the first light source and second light source scan through the ambiguous zone. The method can further include the step of empirically determining the predetermined distance away from the first light (d) and the ambiguous zone(psi). Note, “psi” corresponds to an area within an angle falling within the ambiguous zone. The method can further include continuing to activate the second light source the predetermined distance away from the first light source until the second light source is outside of the ambiguous zone.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a communication system in accordance with an embodiment of the present invention.

FIG. 2 is a partial block diagram of a helmet formed in accordance with another embodiment of the present invention.

FIG. 3 is an electrical block diagram illustrating an example of a location determination device in accordance with an embodiment of the present invention.

FIG. 4 is a top view of a head's up display illustrating an ambiguous zone in accordance with an embodiment of the present invention.

FIG. 5 is an illustration of a typical human eye.

FIG. 6 is an eye pattern chart with peripheral vision rods illustrating receptor density.

FIG. 7 illustrates the architecture of the human eyes.

FIG. 8 is another top view of the head's up display illustrating a proposed solution in accordance with an embodiment of the present invention.

FIG. 9 is an alternative view of the head's up display of FIG. 8 in accordance with an embodiment of the present invention.

FIG. 10 is the top view of FIG. 8 with a portion blown up to illustrate additional details in accordance with an embodiment of the present invention.

FIG. 11 is a flow chart of a method of providing direction indicators or exit route indicators to a user's peripheral line of vision in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of exemplary ways in various devices such as in a rescue system as described in U.S. Patent Publication 2006/0033661, published Feb. 16, 2006 in the name of Motorola, Inc.

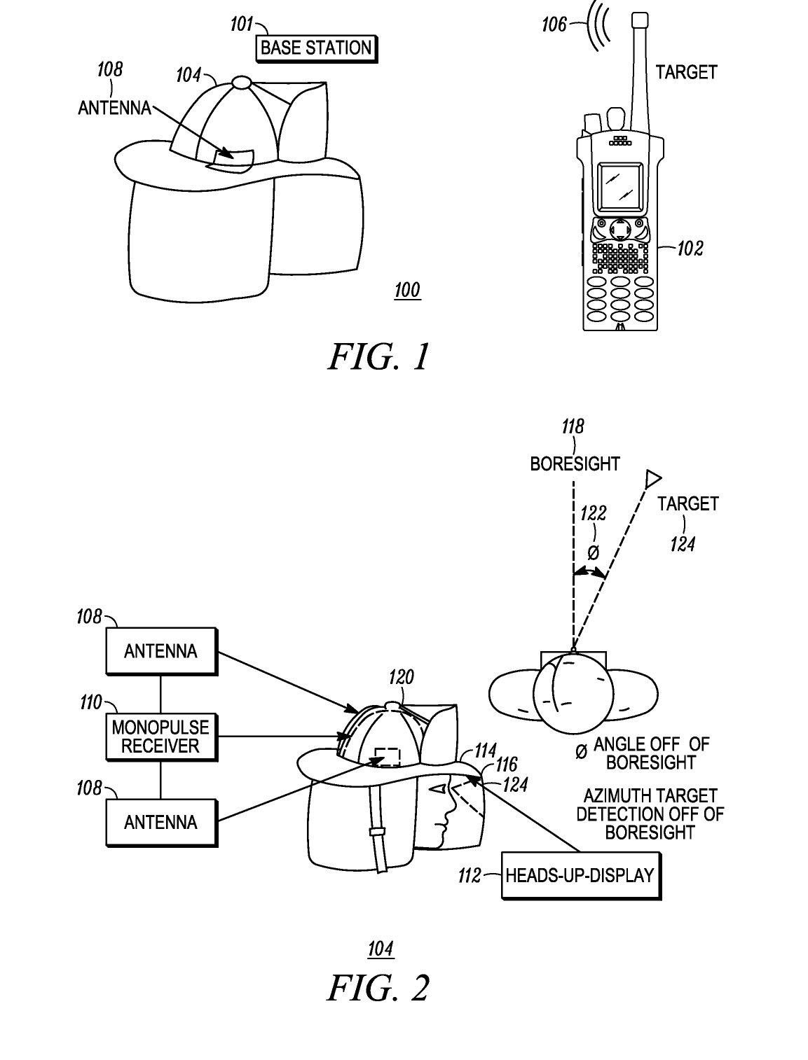

Referring to FIG. 1, there is shown a communication system 100 in accordance with the present invention. Communication system 100 includes a portable radio 102 and in accordance with the present invention, a portable location determination device to be worn on a user's head, preferably in the form of a helmet or hat 104. The communication system 100 can further include a base station 101 as will be further discussed below. In a search and track scenario, the user of helmet 104 is attempting to locate the user of portable radio 102 who is either in a “man-down” or “man-lost” situation and then remove that individual to the closest point of egress. For the purposes of this application, the user of portable radio 102 will also be referred to as a “target” or “second party”. The target may be stationary or moving. The helmet can include a head's up display (HUD) having improved performance in an ambiguous zone or region through the use of an additional light source or LED as will be further detailed below.

The portable radio 102 can generate a transmit signal 106 over a dedicated frequency or schedule of frequencies. The transmit signal 106 can be any signal capable of being received by a receiver such as a monopulse receiver, for example a periodic tone burst at 4.9 GHz or a continuous RF signal. Monopulse is a method known in the art of determining the angular location of a source of radiation or of a “target” that radiates or re-radiates energy.

Referring to FIG. 2, a partial block diagram of helmet 104 formed in accordance with an embodiment of the present invention is shown. Helmet 104 includes a housing 120 having at least two antennas 108 and a monopulse receiver 110 integrated therein with which to scan for an incoming signal. The helmet 104 can provide a “scanning” indicator visible to the peripheral vision 116 of the wearer when within range of and receiving the transmitted signal 106 generated by the portable radio 102. The scanning indicator is preferably integrated within a brim 114 of the helmet 104 to provide a head's-up-display (HUD) 112 which does not impair or obstruct the user's field of view. Helmet 104 preferably includes a face guard 124 to minimize water and smoke intrusion, however the face guard is not required for operation of the location determination functionality. The HUD 112 can take on a variety of form factors, such as blinking or chaser LEDs or other display device known in the art.

The helmet 104 can receive the transmitted signal 106 through the plurality of antennas 108 and then can establish sum and difference patterns of the received signal to determine angular position of portable radio 102 relative to helmet 104. The direction in space in which azimuth and elevation difference patterns both have their nulls is called a boresight axis 118. The sum and difference patterns are used to calculate an angle off of boresight 122 which is used to lead the wearer of the helmet 104 to the target 124 (i.e. location of portable radio 102). In accordance with the present invention, the angle off of boresight 122 is communicated to the wearer of the helmet 104 via the HUD 110. The HUD 110 is dynamically updated as the wearer of the helmet 104 approaches or moves away from target 124. The orientation of the two antennas 108 determines either an azimuth or elevation angle off of boresight. The angular representation shown in FIG. 2 represents azimuth target detection off of boresight 124. To achieve both azimuth and elevation target detection at least four antennas should be incorporated into the helmet 104.

The antennas are preferably selected to establish highly directional pattern or polarization characteristics in the azimuth and elevation planes. Examples of such antennas include but are not limited to yagi or ceramic patch antennas. As previously mentioned, the helmet 104 can include a HUD having improved tracking performance in an ambiguous zone or region in accordance with an embodiment of the invention through the use of an additional light source or LED as will be further detailed below.

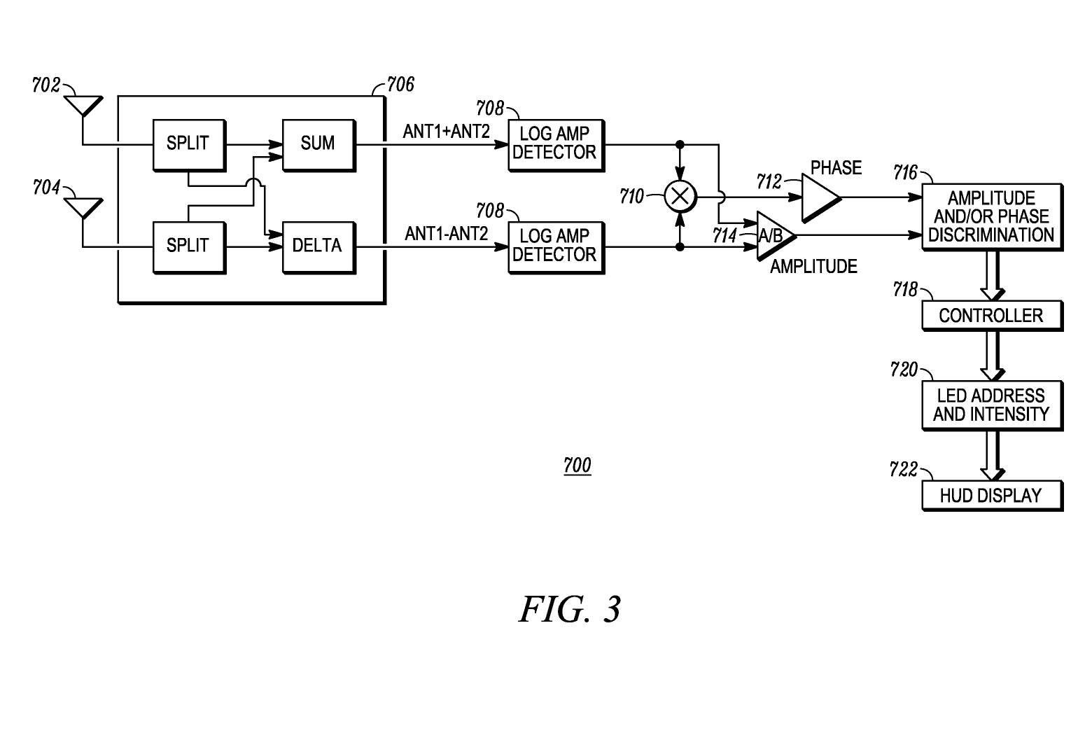

Referring to FIG. 3, an electrical block diagram 700 illustrating an example of a location determination device 700 in accordance with a more detailed embodiment of the invention is shown. First and second antennas 702, 704 receive a transmitted signal from a remote portable device (i.e. the target). Antenna 702, 704 are coupled to a receiver string comprising splitters, differentiators and summers 706, detectors 708, mixer 710, phase detectors 712, signal amplifiers 714 and discriminators 716. The receiver string converts the transmitted signal into angular location information which gets fed to controller 718. Controller 718 converts the angular location data into control signals for the HUD display 722. HUD display 722 provides the location information to the peripheral vision of the wearer of the location determination device 700. The wearer of device 700 can thus follow the display indicator to locate the target.

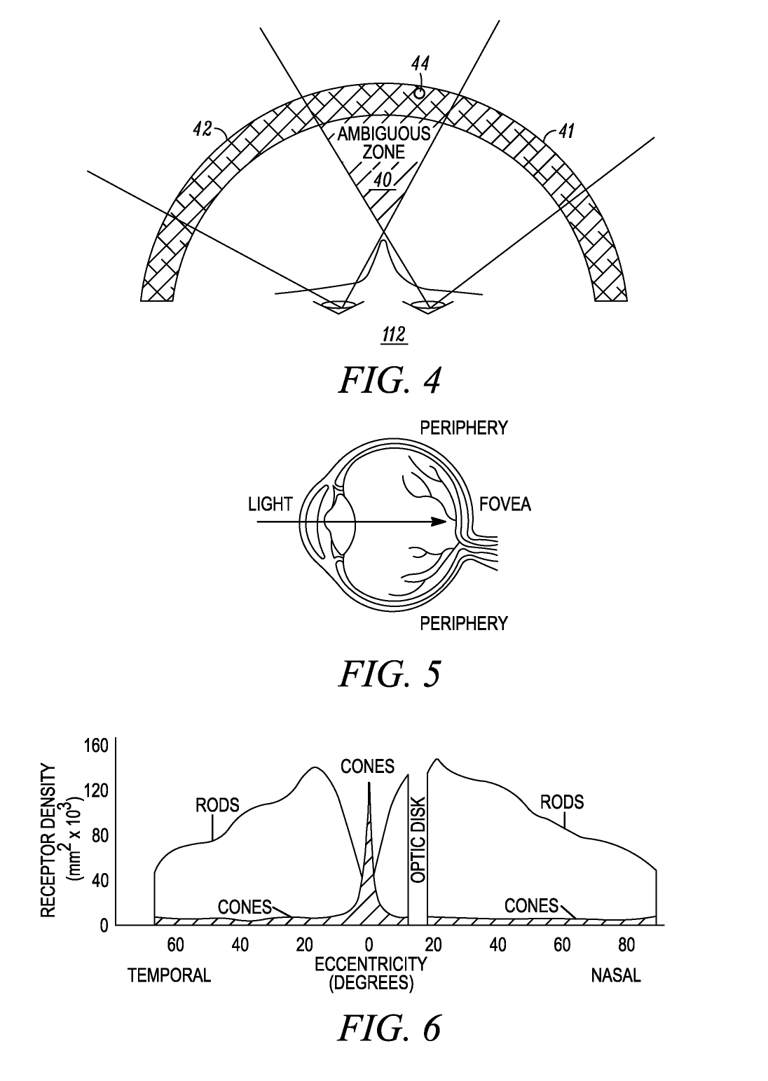

Referring to FIG. 4, an example of an implementation for the HUD 112 (see FIG. 1) in accordance with an embodiment of the present invention is shown. HUD 112 includes an array of lights sources such as LEDs 41 mounted to a substrate 42, such as a flex. Substrate 42 is preferably incorporated into or operatively coupled to the brim of helmet 104 of FIG. 1. The array of LEDs 41 may be multi-colored, single colored or combinations thereof and are distributed so as to be visible to the user's peripheral vision. The array of LEDs 41 is under control of a controller, such as described in FIG. 3, to indicate the location of the target or man-down. The angular location of the target is communicated to the user and updated dynamically as the wearer gets closer to or moves further away from the target or as the target moves about. The display indicator can be provided by continuous or increased flashing of the LEDs and/or increased intensity or color changes. For example, a series of green LEDs can either flash or vary in intensity as the wearer of the device approaches or moves away from the target. The closest point of egress can also be indicated at the same time. For example, a red LED can be used to indicate the closest exit route.

Operationally, the wearer of the helmet 104 can also use a portable communication device, such as a two-way radio, having a Personal Area Network (PAN) device coupled thereto or integrated therein. The PAN device can communicate with both the helmet 104 electronics and a remote base station 101 (as shown in FIG. 1), such as used in an APCO or TETRA radio system. In accordance with this embodiment, base station 101 can relay egress path data, such as the closest exit route heading, to the PAN device, and the PAN device, in turn, can transmit the egress data to the helmet 104. For example, the egress data can be relayed from an APCO base station to the PAN device over an APCO link, and the PAN device can transmit the data through either a wired link or wireless link (e.g. using an 802.11 protocol) to the helmet 104. In accordance with the invention, the helmet 104 processes the incoming egress data signal via the monopulse receiver and controller to provide control signals to the display. The wearer of helmet 104 can simply follow the indicators displayed on the HUD 112 as described above to find the closest exit.

The integration of a plurality of antennas 108, monopulse receiver 110 and HUD 112 into a housing 120 to be worn on a user's head, such as a helmet 104, provides a location determination device ideal for use by rescue personnel to satisfy wireless fidelity (WiFi) data requirements. Those skilled in the art will recognize that a full transceiver and different operating frequencies can be used if desired. Location searching and tracking as well as egress vectors can all be indicated to the wearer of the location determination device formed in accordance with the present invention. Displaying location and egress path indicators to the peripheral vision of the user allows for a natural, intuitive response from the user without distraction and without the use of hands. Smoke and water do not affect the display.

An LED 44 shown in FIG. 4 can represent the last scanned light source or LED illuminated during search and track mode of operation. The LED 44 represents the current state of tracking. It scans if no tracking signal is detected, and locks on if one is detected. Further, FIG. 4 illustrates the peripheral zones for each eye. The overlap region of each zone is referred to as the Ambiguous Zone 40. In the Ambiguous zone 40, the LED 44 appears to be duplicated through the brains inability to merge the images in that region. As a result, the brain sees two LEDs while it is scanning or tracking in that Ambiguous zone or region 40. The image is an optical illusion image.

Additional information about human eyes and how they function with respect to FIGS. 5-7 can further demonstrate why the embodiments herein were created. FIGS. 5 and 6 are alternative representations of the human eye including the optic disk. As suggested in FIG. 6, the optic disk is the spot on the retina where the optic nerve leaves the eye. There are no sensory cells at the optic disk, creating a blind spot. Each eye covers for the blind spot of the other eye and the brain fills in the missing information. The problem is that in the peripheral vision for each eye correlating to the optic nerve, the brain is not trained to compensate for the scan of the LED. Hence, the LED appears to jump and/or duplicate partially due to the optic disk brain processing.

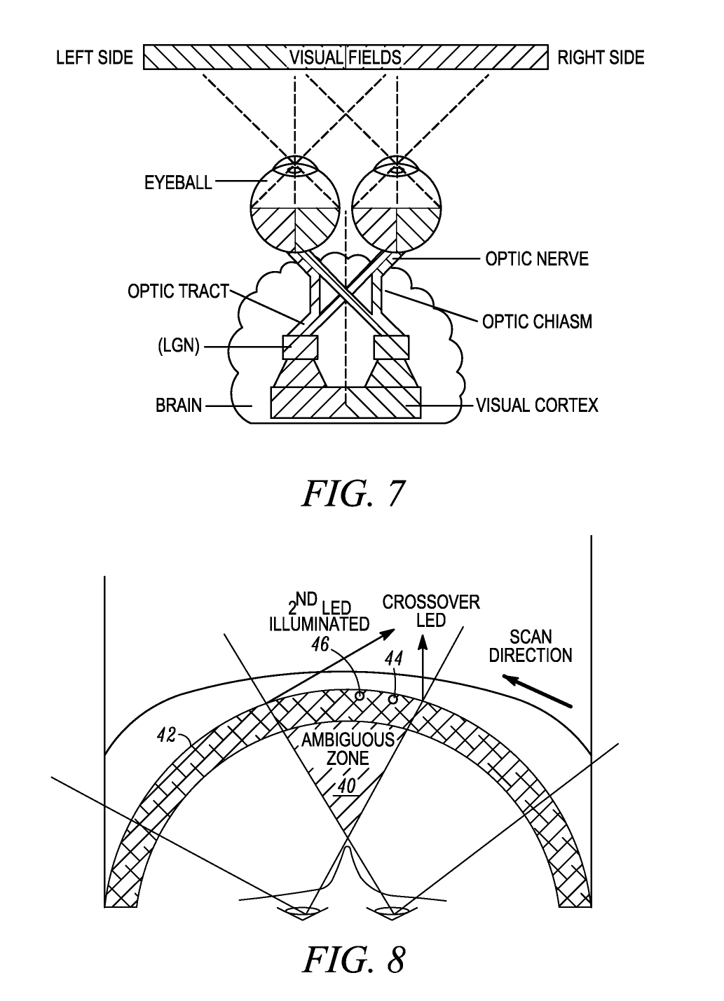

Referring to FIG. 7, the architecture of the human visual system is illustrated. Again, an ambiguous zone can be seen in the cross-over of the inner peripheral vision areas of each eye. As an example of the issue being resolved, if one holds their hands in front of their face while looking at a wall in front of them, and scans their hands across their field of vision, a duplicate of one of the hands will be seen. The specific hand duplicated depends on the scan direction.

All visual information that the human mind receives is processed by a part of the brain known as visual cortex. The visual cortex is part of the outermost layer of the brain, the cortex, and is located at the dorsal pole of the occipital lobe or simply the lower rear of the brain. The visual cortex obtains its information via projections that extend all the way through the brain from the eyeballs. The projections first pass through a stopover point in the middle of the brain, an almond like lump known as the Lateral Geniculate Nucleus, or LGN. From there the projections are projected to the visual cortex for processing.

The visual system as shown in FIG. 7 is the part of the nervous system which allows organisms to see. It interprets the information from visible light to build a representation of the world surrounding the body. The visual system has the complex task of (re)constructing a three dimensional world from a two dimensional projection of that world. The visual system can include the eye, especially the retina, the optic nerve, the optic chiasm, the optic tract, the lateral geniculate nucleus (LGN), the optic radiation, and the visual cortex. The eye is a complex biological device. The functioning of a charge-coupled device (CCD) camera makes an apt metaphor for the workings of the eye, which takes visible light and converts it into a stream of information that can be transmitted via nerves. Light entering the eye is refracted as it passes through the cornea. It then passes through the pupil (controlled by the iris) and is further refracted by the lens. The lens inverts the light and projects an image onto the retina. The retina consists of a large number of photoreceptor cells which contain a particular protein molecule called an opsin. In humans, there are two types of opsins, rod opsins and cone opsins. Rods and cones differ in function. Rods are found primarily in the periphery of the retina and are used to see at low levels of light. Cones are found primarily in the center (or fovea) of the retina and are used primarily to distinguish color and other features of the visual world at normal levels of light.

In the retina, the photoreceptors synapse directly onto bipolar cells, which in turn synapse onto ganglion cells of the outermost layer, that will then conduct action potentials to the brain. A significant amount of visual processing arises from the patterns of communication between neurons in the retina. The information about the image via the eye is transmitted to the brain along the optic nerve. In humans, the optic nerve is connected directly to the brain rather than through exclusive connection through the medulla. This allows processing of complex visual information more quickly than an exclusive connection via the medulla.

The optic nerves from both eyes meet and cross at the optic chiasm, at the base of the frontal lobe of the brain. At this point the information from both eyes is combined and split according to the field of view. The corresponding halves of the field of view (right and left) are sent to the left and right halves of the brain, respectively (the brain is cross-wired), to be processed. That is, though one might expect the right brain to be responsible for the image from the right eye, and the left brain for the image from the left eye, in fact, the right brain deals with the left half of the field of view, and similarly the left brain deals with the right half of the field of view. (Note that the right eye actually perceives part of the left field of view, and vice versa).

Information from the right visual field (now on the left side of the brain) travels in the left optic tract. Information from the left visual field travels in the right optic tract. Each optic tract terminates in the lateral geniculate nucleus (LGN) in the thalamus. The lateral geniculate nucleus (LGN) is a sensory relay nucleus in the thalamus of the brain. The neurons of the LGN then relay the visual image to the primary visual cortex which is located at the back of the brain (caudal end) in the occipital lobe.

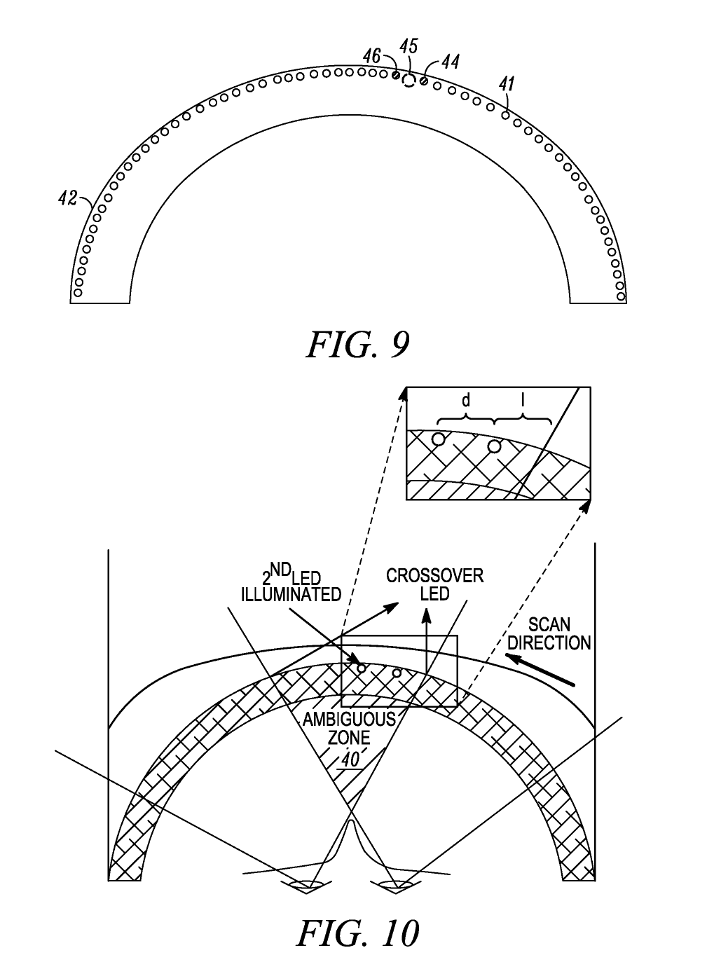

In order to compensate for the optical illusion problem previously described, an additional light source such as LED 46 as shown in FIGS. 8-10 can be illuminated a predetermined distance away from a first light source such as LED 44 as the light source scans across the HUD. The location of the illuminated LED 46 and the optical illusion depends on several factors. It depends on one or more of the scan rate, the distance the HUD is from the eyes, the individual's eye spacing, and Ambiguous zone 40. Many of these factors can be set up or determined empirically. Once determined, the additional LED 46 can be illuminated so as to generate an additional optical illusion image that overlaps with the original LED. The brain now sees three LEDs even though there are only two illuminated. The center light source or LED image 45 as shown in FIG. 9 is the actual heading, and is, in fact, where no LED is actually illuminated. By phase pulse modulation at rates greater than 20 Hz, and 180 degrees out of phase, the third or center “LED” or image 45 appears to be brighter than the others, even though it doesn't actually exist. The use of the additional light source thus provides direction or exit indicators corresponding to real directions or exits external to the display and are not fictitious or fantasy displays merely displayed on the HUD.

Referring to FIG. 10, a blown-up view of a portion of the Ambiguous Zone 40 demonstrates the programming metrics used to illuminate the correct LED in order to resolve an ambiguity in a direction of rescue by illuminating a second LED. The illustration in FIG. 10 highlights the LED separation (d), the anchor point distance from the Ambiguity region (l), and the Ambiguity angle (from Boresight, also referred to LED Crossover).

The computation of scan angle Theta (as shown in FIG. 2), the Ambiguity region from boresight (Psi), L, and d are used to create an appropriate illusion. Psi and d are empirically determined since they are a function of the human head. L is determined as the typical scan offset (Theta) from entering the angle Psi, or ambiguous zone. The second LED follows the first as it enters the scan which yields a smooth transition and eliminates the “jumps” currently experienced using a single LED as the scanning indicator. It is easier for the brain to follow a centerline of a three LED image than a single ambiguous LED.

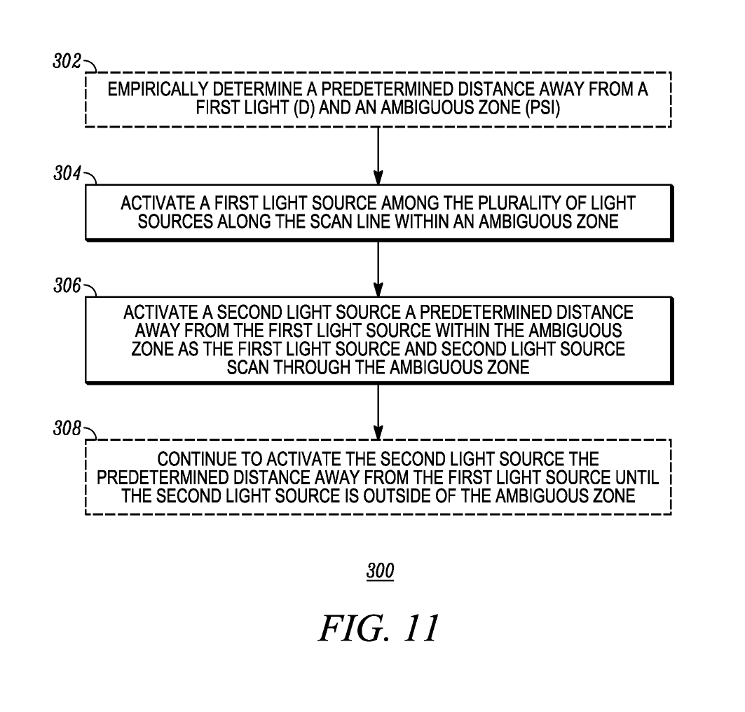

Referring to FIG. 11, a flow chart illustrating a method 300 of providing direction indicators or exit route indicators to a user's peripheral line of vision in the form of a plurality of light sources along a scan line of a head's up display (HUD). The method 300 can include the step 302 of empirically determining a predetermined distance away from a first light (d) and an ambiguous zone(psi). The method 300 can further include the step 304 of activating a first light source among the plurality of light sources along the scan line within the ambiguous zone and the step 306 of activating a second light source the predetermined distance away from the first light source within the ambiguous zone as the first light source and second light source scan through the ambiguous zone. The method 300 can further include the step 308 of continuing to activate the second light source the predetermined distance away from the first light source until the second light source is outside of the ambiguous zone.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A display device, comprising:
a head's up display (HUD), the HUD providing direction indicators or exit route indicators to a user's peripheral line of vision in the form of a plurality of light sources along a scan line of the HUD; and
a processor coupled to the indicators, wherein the processor is programmed to:
activate a first light source among the plurality of light sources along the scan line within an ambiguous zone; and
activate a second light source a predetermined distance away from the first light source within the ambiguous zone as the first light source and second light source scan through the ambiguous zone.

2. The display device of claim 1, wherein a point between the first light source and the second light source indicates a desired direction or an exit route.

3. The display device of claim 1, wherein the plurality of light sources comprises a plurality of light emitting diodes (LEDs).

4. The display device of claim 1, wherein a location of the second light source is activated based on at least one or more among a scan rate, a distance the HUD is away from a user's eyes, a user's eye spacing, and the ambiguous zone.

5. The display device of claim 1, wherein the first light source or the second light source is phase modulated at greater rate than 20 Hertz.

6. The display device of claim 1, wherein the first light source or the second light source is one hundred eighty degrees out of phase.

7. The display device of claim 1, wherein the processor is further coupled to a monopulse receiver.

8. The display device of claim 7, wherein the monopulse receiver is coupled to a plurality of antennas.

9. A communication system, comprising
a head's up display (HUD), the HUD providing direction indicators or exit route indicators to a user's peripheral line of vision; and
a plurality of light sources along a scan line of the HUD automatically activated and controlled to provide an optical illusion to a user within an ambiguous zone of the HUD to provide the direction indicators or exit route indicators.

10. The communication system of claim 9, wherein a point between a first light source and a second light source indicates a desired direction or an exit route.

11. The communication system of claim 9, wherein the plurality of light sources comprises a plurality of light emitting diodes (LEDs).

12. The communication system of claim 10, wherein a location of the second light source is activated based on one or more of a scan rate, a distance the HUD is away from a user's eyes, a user's eye spacing, or the ambiguous zone.

13. The communication system of claim 10, wherein the first light source or the second light source is phase modulated at greater than 20 Hertz and is one hundred eighty degrees out of phase.

14. The communication system of claim 9, wherein the communication system further comprises a processor coupled to a monopulse receiver.

15. The communication system of claim 15, wherein the monopulse receiver is coupled to an antenna array.

16. The communication system of claim 9, wherein the communication further comprises a base station generating a signal including egress data for a predetermined area and a personal area network device coupled to a processor communicating with the base station.

17. A method of providing direction indicators or exit route indicators to a user's peripheral line of vision in the form of a plurality of light sources along a scan line of a head's up display (HUD, comprising the steps of:
activating a first light source among the plurality of light sources along the scan line within an ambiguous zone; and
activating a second light source a predetermined distance away from the first light source within the ambiguous zone as the first light source and second light source scan through the ambiguous zone.

18. The method of claim 17, wherein the method further comprises the step of empirically determining the predetermined distance away from the first light (d) and the ambiguous zone(psi).

19. The method of claim 18, wherein the method comprises continuing to activate the second light source the predetermined distance away from the first light source until the second light source is outside of the ambiguous zone.
